(19) United States
(12) Patent Application Publication
(10) Pub. No.: US 2026/0062123 A1
(43) Pub. Date: Mar. 5, 2026

(54) SAUCER-SHAPED AIRCRAFT

(71) Applicant: Yinghui Guo, Shenzhen (CN)

(72) Inventor: Yinghui Guo, Shenzhen (CN)

(21) Appl. No.: 18/762,692

(22) Filed: Jul. 3, 2024

(30) Foreign Application Priority Data
Jul. 4, 2023 (CN) 202310811159.0

(51) Int. Cl. B64C 39/06; B64C 25/10

(52) U.S. Cl. CPC B64C 39/06; B64C 25/10

(57) ABSTRACT

The present invention is applicable in the technical field of aircraft and provides a saucer-shaped aircraft comprising an aircraft body. The aircraft body is provided with a saucer-shaped wing, and functional vanes that are rotatably connected to the aircraft body and can be unfolded downwards for cushioning in the process of landing are arranged below the saucer-shaped wing. The functional vanes are arranged in numbers, and the functional vanes are arranged around a center of the aircraft body. The aircraft body is further provided with a drive control mechanism for driving the functional vanes to rotate. Each of the functional vanes has an upper end in connection with the aircraft body through a rotating structure, which is located below the saucer-shaped wing and near an outer edge of the saucer-shaped wing. The aircraft body is provided with a locking device for locking the functional vanes when folded up.

### CROSS-REFERENCE TO RELATED APPLICATIONS

The present application claims priority of Chinese Patent Application No. 202310811159.0, filed on Jul. 4, 2023, the entire contents of which are hereby incorporated by reference.

### TECHNICAL FIELD

The present invention pertains to the technical field of aircraft, and in particular, relates to a saucer-shaped aircraft.

### BACKGROUND

As they can be applied in civil aviation and military aviation, saucer-shaped aircraft have huge potential markets and tremendous application value. In the prior art, the saucer-shaped aircraft generally adopt an integral saucer-shaped structure, which provides insufficient cushioning for landing, are affected by such a significant impact force at the moment of landfall as to easily cause damage to components, and therefore have poor safety; in addition, while the existing saucer-shaped aircraft are generally equipped with lift drive devices, they consume a lot of energy and have poor maneuverability. In light of the above technical problems, there is an urgent need for research personnel to improve the saucer-shaped aircraft.

### SUMMARY

It is an objective of the present invention to, in a bid to overcome at least one of the above defects in the prior art, provide a saucer-shaped aircraft, which can provide effective cushioning as functional vanes are unfolded downwards during landing, reduces the impact at the moment of landfall, has good safety and reliability, and improves the service life.

The technical solution of the present invention is: a saucer-shaped aircraft comprising an aircraft body, wherein the aircraft body is provided with a saucer-shaped wing, functional vanes that are rotatably connected to the aircraft body and can be unfolded downwards for cushioning in the process of landing are arranged below the saucer-shaped wing, the functional vanes are arranged in numbers, the functional vanes are arranged around a center of the aircraft body, and the aircraft body is further provided with a drive control mechanism for driving the functional vanes to rotate; each of the functional vanes has an upper end in connection with the aircraft body through a rotating structure, which is located below the saucer-shaped wing and near an outer edge of the saucer-shaped wing.

As a further improvement of the present technical solution, the aircraft body is provided with a locking device for locking two adjacent ones of the functional vanes when folded up.

As a further improvement of the present technical solution, when a lower end of each of the functional vanes is unfolded downwards to a set angle, edges of adjacent ones of the functional vanes are connected or close to each other.

As a further improvement of the present technical solution, one face of the functional vanes is a first side face that can be attached to an inner side of the saucer-shaped wing.

As a further improvement of the present technical solution, the rotating structure comprises rotating shafts that are arranged at a bottom portion of the saucer-shaped wing, the rotating shafts are arranged in numbers and fixedly connected to corresponding functional vanes, respectively; the drive control mechanism comprises a control element, and drive elements that are arranged on the rotating shafts and used to drive the rotating shafts to rotate; the drive elements each are connected to the control element, respectively.

As a further improvement of the present technical solution, the control element has a control unit for adjusting a rotation angle of the functional vanes; or, the drive elements are stepper motors.

As a further improvement of the present technical solution, the drive control mechanism comprises a pneumatic control element and air cylinder assemblies for driving the rotating structure to rotate, and the air cylinder assemblies comprise telescopic rods that are fixedly connected to the functional vanes and retractable; the air cylinder assemblies are arranged in numbers and correspond to the functional vanes; each of the air cylinder assemblies is connected to the pneumatic control element.

As a further improvement of the present technical solution, at least two rotatable propellers are further arranged at a bottom portion of the saucer-shaped wing, and the propellers each are symmetrically distributed around the center of the aircraft body; the lift propellers are arranged adjacent to the functional vanes and located closer to the center of the aircraft body relative to the functional vanes.

As a further improvement of the present technical solution, the edge of the saucer-shaped wing is provided with an outer edge wing that tilts upwards to provide a lifting force; an angle between the outer edge wing and a horizontal direction is 4 degrees to 10 degrees.

As a further improvement of the present technical solution, the aircraft body comprises a cabin, which is located at a middle portion of the aircraft body, and a foldable landing gear is arranged at a bottom portion of the cabin; a cabin door that can be opened and closed is arranged at a bottom portion of the cabin, and the cabin door has multiple steps.

A saucer-shaped aircraft provided by the present invention comprises an aircraft body, the aircraft body is provided with a saucer-shaped wing, functional vanes that are rotatably connected to the aircraft body and can be unfolded downwards for cushioning in the process of landing are arranged below the saucer-shaped wing, the functional vanes are arranged in numbers, and the functional vanes are arranged around a center of the aircraft body; the aircraft body is further provided with a drive control mechanism for driving the functional vanes to rotate; each of the functional vanes has an upper end in connection with the aircraft body through a rotating structure, which is located below the saucer-shaped wing and near an outer edge of the saucer-shaped wing; as the rotating structure rotates, the functional vanes are unfolded downwards to form an enclosed cushioning structure, which can realize better cushioning in the process of landing; even if an accident happens to a power device of the saucer-shaped aircraft, the functional vanes are unfolded downwards to form a parachute-like protective structure; even if the power device stops, the unfolded functional vanes enable the aircraft to maintain certain stability, and buy the time for the restart of the power device, which can help prevent the saucer-shaped aircraft from falling directly, with better safety and reliability; in the process of normal landing, as the functional vanes are unfolded downwards, the impact can also be reduced at the moment of landfall, and the overall service life can be improved; when the saucer-shaped aircraft is flying or landing normally, the functional vanes can be folded by rotating the rotating structure, and both folding and unfolding are just easy; moreover, the structure is simple, the operation is convenient, and the cost is low.

### BRIEF DESCRIPTION OF DRAWINGS

To make the technical solutions in the embodiments of the present invention clearer, a brief introduction will be given below to the drawings that need to be used in the embodiments. It is evident that the drawings described below only relate to some embodiments of the present invention. For those skilled in the art, other drawings can be obtained based on these drawings without creative labor.

FIG. 1 is a structure diagram of a saucer-shaped aircraft with functional vanes folded as provided in an embodiment of the present invention;

FIG. 2 is another structure diagram of a saucer-shaped aircraft with functional vanes folded as provided in an embodiment of the present invention;

FIG. 3 is a front view of a saucer-shaped aircraft with functional vanes folded as provided in an embodiment of the present invention;

FIG. 4 is a cutaway diagram of an A-A section in FIG. 3;

FIG. 5 is a bottom view of a saucer-shaped aircraft with functional vanes folded as provided in an embodiment of the present invention;

FIG. 6 is a cutaway diagram of a B-B section in FIG. 3;

FIG. 7 is a structure diagram of a saucer-shaped aircraft with functional vanes unfolded as provided in an embodiment of the present invention;

FIG. 8 is another structure diagram of a saucer-shaped aircraft with functional vanes unfolded as provided in an embodiment of the present invention;

FIG. 9 is another structure diagram of a saucer-shaped aircraft with functional vanes unfolded as provided in an embodiment of the present invention;

FIG. 10 is another structure diagram of a saucer-shaped aircraft with functional vanes unfolded as provided in an embodiment of the present invention.

### REFERENCE SIGNS IN THE FIGURES

1. aircraft body; 11. cabin; 12. landing gear; 13. cabin door; 131. step; 2. saucer-shaped wing; 21. mounting bracket; 3. functional vanes; 31. first side face; 4. drive control mechanism; 41. telescopic rod; 5. rotating structure; 51. rotating shaft; 6. propeller; 7. outer edge wing.

### DESCRIPTION OF EMBODIMENTS

To make the objective, technical solutions, and advantages of the present invention understood more clearly, the present invention will be further elaborated as below in combination with the drawings and embodiments. It should be understood that the specific embodiments described herein are only intended to explain the present invention, rather than limit the present invention.

It should be noted that the terms “arrange” and “connect” should be understood in a broad sense, for example, they can be direct arrangement or connection, or indirect arrangement or connection through intermediate components or structures.

In addition, if there are terms indicating orientation or positional relationship, such as “longitudinal”, “transverse”, “length”, “width”, “thickness”, “upper”, “lower”, “front”, “back”, “left”, “right”, “vertical”, “horizontal”, “top”, “bottom”, “inner”, and “outer”, in the embodiments of the present invention, they are just intended to facilitate describing the present invention and simplify the illustrations based on the orientation or positional relationship shown in the drawings or the conventional state of placement or use, rather than indicate or imply that the structure, feature, device, or element referred to must have specific orientation or positional relationship, nor must they be constructed or operated in a specific orientation. Therefore, these terms cannot be understood as limitations on the present invention. In the illustrations of the present invention, unless otherwise specified, “multiple”means two or more.

Specific technical features and embodiments described in the specific implementation manners can be combined with each other in any suitable way, under the circumstances that they are not contradictory. For example, combinations of different specific technical features/embodiments can form different implementation manners. To avoid unnecessary repetition, possible combinations of specific technical features/embodiments in the present invention will not be explained separately.

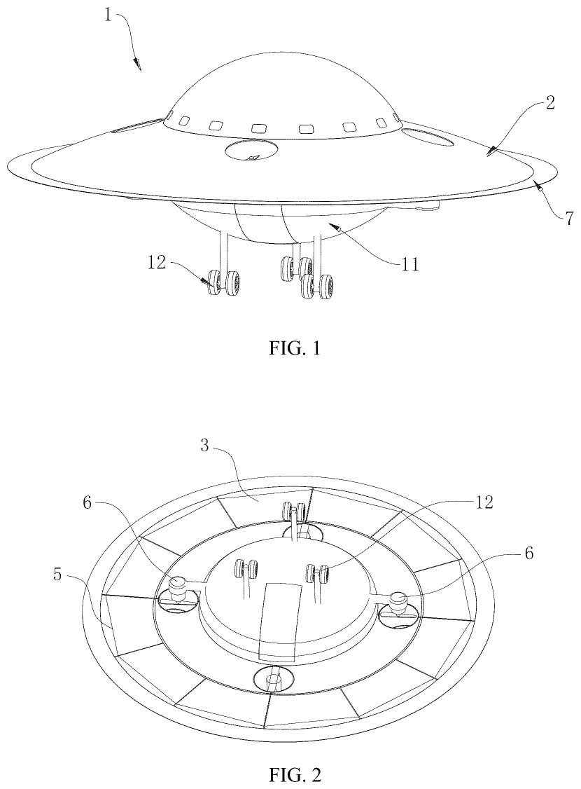

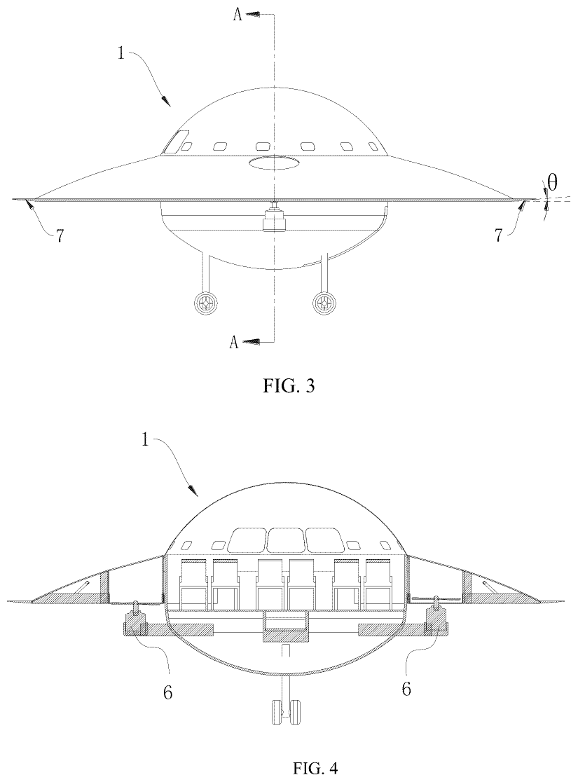

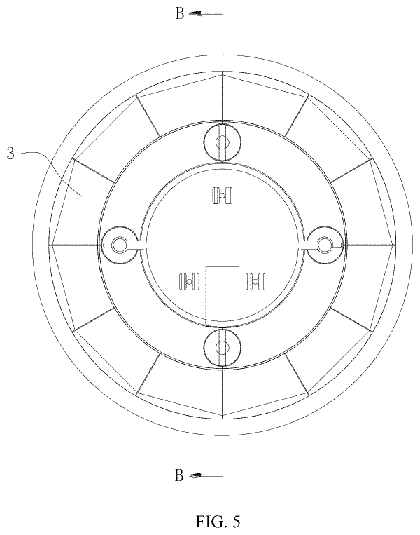

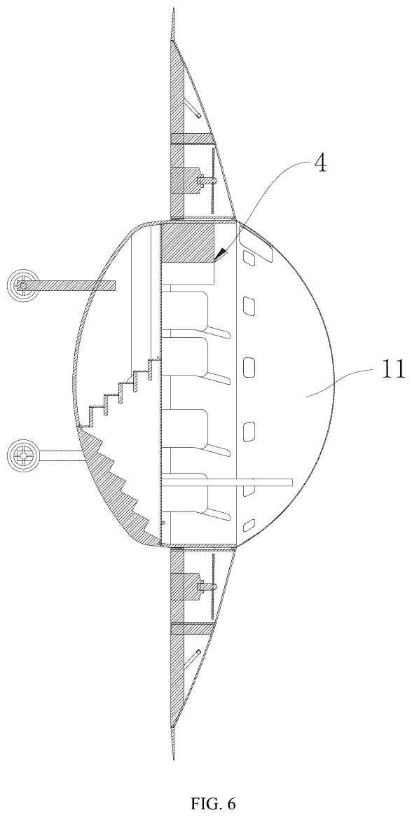

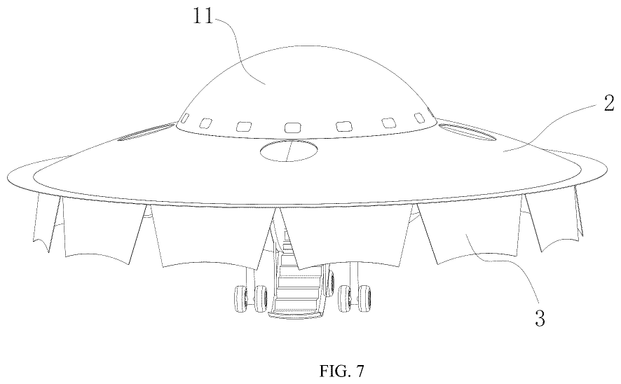

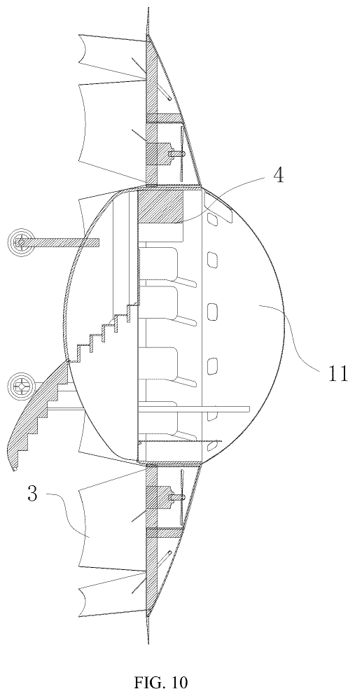

As shown in FIGS. 1 to 10, a saucer-shaped aircraft provided in the embodiments of the present invention comprises an aircraft body 1; the aircraft body 1 is provided with a saucer-shaped wing 2; functional vanes 3 are arranged below the saucer-shaped wing 2; the functional vanes 3 are rotatably connected to the aircraft body 1 and can be unfolded downwards, which can provide cushioning in the process of landing of the saucer-shaped aircraft; the functional vanes 3 are arranged in numbers, and the functional vanes 3 are arranged around a center of the aircraft body 1; the aircraft body 1 is further provided with a drive control mechanism 4; as the drive control mechanism 4 drives the functional vanes 3 to rotate, an upper ends of each of the functional vanes 3 is connected to the aircraft body 1 through a rotating structure 5; the rotating structure 5 is located below the saucer-shaped wing 2 and near an outer edge of the saucer-shaped wing 2. In a saucer-shaped aircraft provided in the embodiments of the present invention comprises an aircraft body, as the rotating structure rotates, the functional vanes 3 are unfolded downwards to form an enclosed cushioning structure, which can realize better cushioning in the process of landing; even if an accident happens to a power device of the saucer-shaped aircraft, the functional vanes 3 are unfolded downwards to form a parachute-like protective structure; even if the power device stops, the unfolded functional vanes 3 enable the aircraft to maintain certain stability, and buy the time for the restart of the power device, which can help prevent the saucer-shaped aircraft from falling directly, with better safety and reliability; in the process of normal landing, as the functional vanes 3 are unfolded downwards, the impact can also be reduced at the moment of landfall, and the stability and safety can be enhanced when the saucer-shaped aircraft lands, in favor of improving the overall service life; when the saucer-shaped aircraft is flying or landing normally, the functional vanes 3 can be folded by rotating the rotating structure, in favor of reducing drag in flight and decreasing the energy consumption; moreover, the structure is simple, the operation is convenient, and the cost is low.

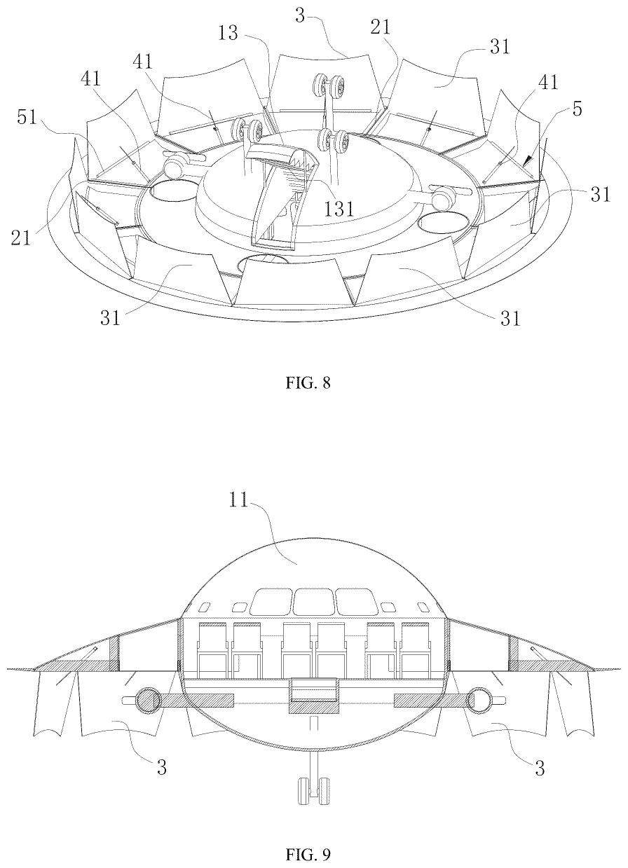

In some embodiments, when a lower end of each of the functional vanes 3 is unfolded downwards to a set angle, edges of adjacent ones of the functional vanes 3 are connected to each other or close to connection with each other, which increases the stability of functional vanes 3 and further provides a greater cushioning force when unfolded downwards; in specific applications, when each of the functional vanes 3 is folded up, the functional vanes 3 each are enclosed to form a circular ring, as shown in FIG. 5; moreover, there is no gap between two adjacent ones of the functional vanes 3, i.e., seamless connection; alternatively, multiple mounting brackets 21 (as shown in FIG. 8) are arranged at a bottom portion of the saucer-shaped wing 2; the saucer-shaped aircraft further comprises multiple sealing strips that are arranged on the mounting brackets 21 and used to seal gaps between the functional vanes 3, which can further ensure that adjacent functional vanes 3 are seamlessly connected after the functional vanes 3 are folded up; the sealing strips can have certain stickiness; alternatively, adsorptive sealing strips are arranged on both sides of each of the functional vanes 3; when the functional vanes 3 are folded up, the adsorptive sealing strips arranged on the opposite sides of the adjacent ones of the functional vanes 3 can adsorb each other; as the functional vanes 3 have certain elasticity, the adsorptive sealing strips can stretch the functional vanes 3 and ensure the seamless connection when they adsorb each other; the adsorptive sealing strip can have certain stickiness. When they are folded up, the functional vanes 3 can be neatly tucked away at a bottom portion of the saucer-shaped aircraft; the functional vanes 3 will not cause turbulence, to ensure the stability and safety in flight. The aircraft body 1 is provided with a locking device, which is used to lock the functional vanes 3 when folded up; when the functional vanes 3 are tucked away at the bottom portion of the saucer-shaped aircraft, they can be locked through the locking device and tightly attached to the bottom portion of the aircraft body 1. In other words, the locking device can be an electronic control lock (including electronic mechanical locks, etc.); in specific applications, it can be an electromagnetic lock among others. The locking device can be operated and controlled in a manner of electronic control; in specific applications, a mechanical transmission structure can also be arranged to be connected to the locking device and the functional vanes 3; the mechanical transmission structure can be a winch mechanism among others, which can be manually operated to make the locking device and functional vanes 3 move, i.e., unlock the locking device and rotate the functional vanes 3 to unfold or fold. Under special circumstances, e.g., when the electronic control system malfunctions, the locking device can be unlocked and the functional vanes 3 can be unfolded through the mechanical transmission structure, so as to achieve a cushioning effect, avoid the aircraft from accidental stall and the like, and have higher safety and reliability. The unfolded functional vanes 3 can improve the stability and safety of the aircraft. The unfolded functional vanes 3 are conducive to reducing the energy consumption of the aircraft in postures such as hovering. The set angle can be between 90 degrees and 165 degrees; in specific applications, the set angle can be any angle between 90 degrees and 135 degrees (90 degrees to 110 degrees); in the present embodiment, the set angle is 100 degrees, which can provide a sufficient cushioning force; main bodies of the functional vanes 3 can be made from high-strength alloy materials or composite materials, such as titanium alloy and carbon fiber. One face of the functional vanes 3 is a first side face 31 that can be attached to an inner side of the saucer-shaped wing 2; in specific applications, the functional vanes 3 can have a shape of a rough trapezoid, the upper end is longer than the lower end, and the lower end is curved; the functional vanes 3 can be curved and slightly warped, and when folded up, they can be attached to the inner side of the saucer-shaped wing 2; at this time, they are in a folded state; when flipped to a set angle with the saucer-shaped wing 2, they are in an stretched state; in one embodiment, the functional vanes 3 can switch between the stretched state and the folded state, and the functional vanes 3 can be flipped, folded, and used as horizontal vanes; and they can be vertical or horizontal, and opened as a parachute; it is worth noting that in other embodiments, the stretched state can also be understood as the functional vanes 3 rotating to any angle and hovering.

In some embodiments, the rotating structure 5 comprises rotating shafts 51 that are located at the bottom portion of the saucer-shaped wing 2; the rotating shafts 51 are arranged in numbers and fixedly connected to corresponding functional vanes 3, respectively. For the above drive control mechanism 4, specific explanations will be made through the following embodiments.

### Embodiment 1

The drive control mechanism 4 comprises a control element and drive elements, wherein the drive elements are arranged on the rotating shafts 51 and can drive the rotating shafts 51 to rotate; the drive elements each are connected to the control element, respectively. The number of the drive elements is the same as that of the rotating shafts 51; the control element can be arranged to be single and have a control unit for controlling a rotation angle of the functional vanes 3, and sends a control signal (e.g., the control signal is a rotation duration signal) via the control unit; the drive elements are electric motors; as the electric motors receive a rotation signal, the rotation angle of the electric motors can be controlled, and the rotating shafts 51 are further controlled to rotate to a set angle.

### Embodiment 2

While the rotating shafts 51 and the control element are the same as in Embodiment 1, the difference from Embodiment 1 lies in that the drive elements are stepper motors, the rotation angle of the stepper motors can be controlled via a single control element, and each rotating shaft 51 can also be controlled to rotate to a set angle.

### Embodiment 3

While the rotating shafts 51 are the same as in Embodiments 1 and 2 as mentioned above, the difference lies in that the present embodiment uses an air-cylinder-driven rotating structure 5 (or a hydraulic-cylinder-driven rotating structure) to drive the functional vanes 3 to rotate. The drive control mechanism 4 comprises a pneumatic control element (or a hydraulic control element), air cylinder assemblies (or hydraulic assemblies) for driving the rotating structure 5 to rotate; the air cylinder assemblies comprise telescopic rods 41 that are fixedly connected to the functional vanes 3 and retractable; the air cylinder assemblies are arranged in numbers and correspond to the functional vanes 3; each of the air cylinder assemblies is connected to the pneumatic control element. In the present embodiment, the telescopic rods 41 are arranged in numbers, and each of the telescopic rods 41 is controlled to extend and retract through the pneumatic control element, and further pushes the functional vanes 3 to unfold downwards to form an umbrella-like structure and provide cushioning.

### Embodiment 4

The difference from Embodiment 3 is that the air cylinder assembly is arranged to be single, and the rotating shaft 51 corresponding to the adjacent functional vanes 3 is provided with a linkage mechanism; the telescopic rod 41 can be arranged to be single; of course, it can also be arranged at the bottom portion of each of the functional vanes 3; the telescopic rod 41 is driven by a single air cylinder assembly to extend and retract; the linkage mechanism drives each of the functional vanes 3 to rotate and unfold downwards; the linkage mechanism can be a bevel gear transmission mechanism, which comprises a transmission shaft, a first bevel gear arranged at an end portion of the rotating shaft 51, and a second bevel gear engaging with the first bevel gear; the second bevel gear is sleeved on the transmission shaft; the end portion of the transmission shaft is connected to the bottom portion of the adjacent functional vanes 3 and drives them to rotate; the rest can be done in the same manner, so that each functional vane 3 can move synchronously, thereby realizing synchronous unfolding; of course, multiple air cylinder assemblies can also be arranged, and the number of the air cylinder assemblies can be less than that of the functional vanes 3; for example, every three functional vanes 3 are pushed by one air cylinder assembly to unfold downwards, or two adjacent functional vanes 3 are driven by one air cylinder assembly, both of which are feasible.

Of course, the linkage mechanism in Embodiment 4 as mentioned above can be applied to the case where the electric motors are used to drive in Embodiment 1 or 2, which can reduce the number of the drive elements as arranged, and further effectively reduce the overall weight; this is very beneficial for aircraft design, since the practice can reduce the energy consumption, extend the flight time, and facilitate the cost control.

In some embodiments, at least two rotatable propellers 6 (power devices) are further arranged at the bottom portion of the saucer-shaped wing 2; the propellers 6 each are symmetrically distributed around the center of the aircraft body 1; the propellers 6 are arranged adjacent to the functional vanes 3 and located closer to the center of the aircraft body 1 relative to the functional vanes 3. In specific applications, there are two propellers 6 in the present embodiment; when the saucer-shaped aircraft takes off or lifts upwards, the two propellers 6 can rotate to the vertical direction, in the same straight line as the flight direction, which facilitates providing a lifting force; when the saucer-shaped aircraft is flying horizontally, the two propellers 6 rotate to the horizontal direction, in the same straight line as the flight direction, which can provide a forward propulsive force; the propellers 6 are arranged adjacent to the functional vanes 3 and located on the inner side of the functional vanes 3, making the structure more compact; in another embodiment, the propellers 6 can also be used as a steering device; the propellers 6 are arranged to be two; the aircraft body 1 further comprises a steering control component for controlling the advance speed of the propeller 6; as the steering control component controls the advance speed of the two propellers 6 separately, the steering or flight attitude of the saucer-shaped aircraft can be controlled; the control is convenient; in terms of specific control of the aircraft attitude, the climbing and flight angles can be adjusted by adjusting the elevation angle of the engines (the propellers 6), and the steering can be achieved by adjusting the difference in velocity or propulsive force of the left and right engines; the engines can be propeller engines or jet engines, and the power can be supplied by fuel engines or a power battery pack; the rotatable angle of the engines can be 90 degrees from parallel to horizontal vanes to vertical thereto; when the propellers 6 are arranged to be at least four, at least two (or more) of them are fixed vertical engines that can be used to increase the propulsive force during vertical takeoff or landing and as backup in emergency situations; the top portion or bottom portion of the vertical engine is provided with movable cover plates that can be opened and closed; the movable cover plates are connected to an opening and closing drive mechanism for driving the movable cover plates to rotate or move; when a great lifting force is required during ascent and the like, the opening and closing drive mechanism can drive the movable cover plates to keep the through-hole open; when a great lifting force is not required during level flight and the like, the opening and closing drive mechanism can drive the movable cover plates to keep the through-hole closed, thereby avoiding the formation of turbulence, reducing the air resistance, and decreasing the energy consumption; they can be opened during takeoff and landing and closed during flight, and the vertical engines are concealed in the top vane and the horizontal flight vane, without affecting its horizontal flight; as the saucer-shaped aircraft provided in the present embodiment can taxi for takeoff and landfall, take off and land vertically, hover for a long time, and realize a slow descent with safety in emergency situations, it has great social and economic value; the functional vanes 3 can form a large circular wing in a locked state, which plays an important role in supporting the lifting force of the aircraft in flight; when the functional vanes 3 are unfolded, they form a similar parachute state to the fan-shaped top wing at the top portion, and provide vertical lift support and landing protection.

In some embodiments, the edge of the saucer-shaped wing 2 is provided with an outer edge wing 7 that tilts upwards to provide an upward lifting force; the angle θ between the outer edge wing 7 and the horizontal direction is 4 degrees to 10 degrees. In the present embodiment, the angle θ between the outer edge wing 7 and the horizontal direction is about 5 degrees, which provides a lifting force for lift, facilitates reducing the energy consumption, and improves the maneuverability.

In some embodiments, the aircraft body 1 comprises a cabin 11, which is located at a middle portion of the aircraft body 1, and a foldable landing gear 12 is arranged at a bottom portion of the cabin 11; a cabin door 13 that can be opened and closed is arranged at the bottom portion of the cabin 11, and the cabin door 13 has multiple steps 131 for personnel to enter and exit the cabin.

The embodiments of the present invention further provide a control method for controlling the extension and retraction of the functional vanes 3 in the saucer-shaped aircraft, comprising an extension step and a retraction step; the extension step is: when the saucer-shaped aircraft lands, unfolding the functional vanes 3 downwards for cushioning in the process of landing by rotating the rotating structure 5; the retraction step is: when the saucer-shaped aircraft is flying or landing, folding the functional vanes 3 by rotating the rotating structure 5. The functional vanes 3 are unfolded downwards to form an enclosed cushioning structure, which can achieve better cushioning in the process of landing; even if an accident happens to the power device of the saucer-shaped aircraft, the functional vanes 3 are unfolded downwards to form a parachute-like protective structure; even if the power device stops, the unfolded functional vanes enable the aircraft to maintain certain stability, and buy the time for the restart of the power device, which can help prevent the saucer-shaped aircraft from falling directly, with better safety and reliability; in the process of normal landing, as the functional vanes 3 are unfolded downwards, the impact can also be reduced at the moment of landfall, and the stability and safety can be enhanced when the saucer-shaped aircraft lands, in favor of improving the overall service life; when the saucer-shaped aircraft is flying or landing normally, the functional vanes 3 can be folded by rotating the rotating structure, in favor of reducing drag in flight and decreasing the energy consumption; moreover, the structure is simple, the operation is convenient, and the cost is low.

A saucer-shaped aircraft provided by the present invention comprises an aircraft body 1, the aircraft body 1 is provided with a saucer-shaped wing 2, functional vanes 3 that are rotatably connected to the aircraft body 1 and can be unfolded downwards for cushioning in the process of landing are arranged below the saucer-shaped wing 2, the functional vanes 3 are arranged in numbers, and the functional vanes 3 are arranged around a center of the aircraft body 1; the aircraft body 1 is further provided with a drive control mechanism 4 for driving the functional vanes 3 to rotate; each of the functional vanes 3 has an upper end in connection with the aircraft body 1 through a rotating structure 5, which is located below the saucer-shaped wing 2 and near an outer edge of the saucer-shaped wing 2; as the rotating structure 5 rotates, the functional vanes 3 are unfolded downwards and used for cushioning in the process of landing, reducing the impact at the moment of landfall, and improving the overall service life; when the saucer-shaped aircraft is flying or landing, the functional vanes 3 can be folded by rotating the rotating structure 5, and both folding and unfolding are just easy; moreover, the structure is simple, the operation is convenient, and the cost is low.

The above embodiments are only preferred ones of the present invention, and are not intended to limit the present invention. Any amendments, equivalent substitutions, or improvements that are made within the spirit and principles of the present invention shall fall within the scope of protection of the present invention.

1. A saucer-shaped aircraft, comprising an aircraft body, wherein the aircraft body is provided with a saucer-shaped wing, functional vanes that are rotatably connected to the aircraft body and can be unfolded downwards for cushioning in the process of landing are arranged below the saucer-shaped wing, the functional vanes are arranged in numbers, and the functional vanes are arranged around a center of the aircraft body; the aircraft body is further provided with a drive control mechanism for driving the functional vanes to rotate; each of the functional vanes has an upper end in connection with the aircraft body through a rotating structure, which is located below the saucer-shaped wing and near an outer edge of the saucer-shaped wing.

2. The saucer-shaped aircraft of claim 1, wherein the aircraft body is provided with a locking device for locking two adjacent ones of the functional vanes when folded up.

3. The saucer-shaped aircraft of claim 1, wherein when a lower end of each of the functional vanes is unfolded downwards to a set angle, edges of adjacent ones of the functional vanes are connected or close to each other.

4. The saucer-shaped aircraft of claim 1, wherein one face of the functional vanes is a first side face that can be attached to an inner side of the saucer-shaped wing.

5. The saucer-shaped aircraft of claim 1, wherein the rotating structure comprises rotating shafts that are arranged at a bottom portion of the saucer-shaped wing, the rotating shafts are arranged in numbers and fixedly connected to corresponding functional vanes, respectively; the drive control mechanism comprises a control element and drive elements that are arranged on the rotating shafts and used to drive the rotating shafts to rotate; the drive elements each are connected to the control element, respectively.

6. The saucer-shaped aircraft of claim 5, wherein the control element has a control unit for adjusting a rotation angle of the functional vanes; or, the drive elements are stepper motors.

7. The saucer-shaped aircraft of claim 1, wherein the drive control mechanism comprises a pneumatic control element and air cylinder assemblies for driving the rotating structure to rotate, and the air cylinder assemblies comprise telescopic rods that are fixedly connected to the functional vanes and retractable; the air cylinder assemblies are arranged in numbers and correspond to the functional vanes; each of the air cylinder assemblies is connected to the pneumatic control element.

8. The saucer-shaped aircraft of claim 1, wherein at least two rotatable propellers are further arranged at a bottom portion of the saucer-shaped wing, and the propellers each are symmetrically distributed around the center of the aircraft body; the propellers are arranged adjacent to the functional vanes and located closer to the center of the aircraft body relative to the functional vanes.

9. The saucer-shaped aircraft of claim 1, wherein the edge of the saucer-shaped wing is provided with an outer edge wing that tilts upwards to provide a lifting force;
an angle between the outer edge wing and a horizontal direction is 4 degrees to 10 degrees.

10. The saucer-shaped aircraft of claim 1, wherein the aircraft body comprises a cabin, which is located at a middle portion of the aircraft body, and a foldable landing gear is arranged at a bottom portion of the cabin; a cabin door that can be opened and closed is arranged at a bottom portion of the cabin, and the cabin door has multiple steps.
